(19) United States
(12) Patent Application Publication
(10) Pub. No.: US 2025/0102430 A1
(43) Pub. Date: Mar. 27, 2025

(54) SENSOR ASSEMBLY, AGRICULTURAL MACHINE AND ASSOCIATED METHOD

(71) Applicant: DEERE & COMPANY, MOLINE, IL (US)

(72) Inventors: WOLFRAM HAIGES, GUGLINGEN (DE); STEFAN WELSCH, MANDELBACHTAL ORMESHEIM (DE); CHRISTOPH PELTZ, KAISERSLAUTERN (DE); JOHANNES CHRISTMANN, STEINBACH AM GLAN (DE); GEORG HOCHREITER, CONTWIG (DE)

(21) Appl. No.: 18/882,842

(22) Filed: Sep. 12, 2024

(30) Foreign Application Priority Data
Sep. 26, 2023 (DE) 102023126147.9

(51) Int. Cl. G01N 21/359; A01D 41/127; G01N 21/3563; G01N 21/84

(52) U.S. Cl. CPC G01N 21/359; A01D 41/1277; G01N 21/3563; G01N 21/84; G01N 2021/8466

(57) ABSTRACT

A sensor assembly comprising a sensor, which is designed to record at least one property of a sample and a measurement chamber having an inlet through which the sample can be introduced into the measurement chamber, wherein the sensor is designed to interact with the sample contained in the measurement chamber and to ascertain its properties. The inlet is connectable to a line through which material which is conveyed in an agricultural machine can be guided into the measurement chamber through the inlet as a sample, and the line can be separated from the inlet of the measurement chamber and, instead of the line, a filling device for introducing a sample can be coupled to the inlet.

### CROSS-REFERENCE TO RELATED APPLICATIONS

This application claims priority under 35 U.S.C. § 119 to patent application DE 102023126147.9, filed on 26 Sep. 2023, the disclosure of which is incorporated herein by reference.

### FIELD OF THE DISCLOSURE

The present disclosure relates to a sensor assembly, an agricultural machine equipped therewith, and a corresponding method.

### BACKGROUND OF THE DISCLOSURE

In the past, different sensors for recording properties of crops (such as capacitive moisture sensors, cameras and near infra-red spectrometers) were proposed to give the operator of a combine harvester an indication of the current properties of the crop in the harvesting machine, on the basis of which the operator (or an automatic control) may alter parameters of the machining process, or to document the recorded properties in particular in a site-specific manner.

However, other harvesting machines, such as balers or field choppers, are also equipped with sensors for recording properties of crops, be it to plot these properties in a site-specific manner for precision agriculture purposes or to set machining parameters of the crop automatically based on the measured properties of the crop or via the operator based on a display showing the properties of the crop. Sensors of this type are also used on other agricultural machines, e.g., on seeders for recording properties of the seeds to be applied or on slurry spreaders for recording the substance contents of the slurry to be applied.

Previously, sensors have been arranged adjacent to a channel along which the material flows during operation (as in EP 1 523 874 A1 or US 2022/0132736 A1) or they were mounted on a branch line to which a proportion of the material is fed and recorded flowing or stationary material (c.f., for example, WO 2006/010761 A1, U.S. Pat. No. 6,285,198 B1, US 2002/0133309 A1, EP 0 908 086 A1, DE 10 2010 062 417 A1).

Since near infra-red spectrometers, in particular, are very expensive, the sensors are often removably mounted on the agricultural machine and may also be used to analyze other materials in that they are mounted, for example, on a different holder, i.e. used as stationary sensors (EP 1 523 874 A1), or optionally positioned on a conveyor belt on which the crop is conveyed past them, or immersed manually in a tank containing the crop (US 2002/0039186 A1).

If the sensor is removed from the agricultural machine and used at a different point, the problem arises that a device is needed to present the sample to be analyzed to the sensor. To this end, a separate cost-intensive sample presentation device (see WO 01/69213 A2 and EP 1 523 874 A1) is required—at least if the material to be analyzed should preferably flow past the sensor—in order to obtain a sufficiently high number of measurement values for the sample and to reduce the likelihood of errors or improve the statistics. Moreover, with the sensor mounted on the agricultural machine, it is not possible to analyze a sample other than the material which is conveyed in the machine and fed to the sensor in each case.

Other objects of the present disclosure will be apparent when the description of the disclosure is read in conjunction with the accompanying drawings. The accompanying drawings provided herein are merely illustrative and are not intended to limit the scope and ambit of the present disclosure.

### SUMMARY OF THE DISCLOSURE

A sensor assembly comprising a sensor, which is designed to record at least one property of a sample, and a measurement chamber having an inlet, through which the sample can be introduced into the measurement chamber, wherein the sensor is designed to interact with the sample contained in the measurement chamber and to ascertain its properties, and wherein the inlet is connectable to a line through which material which is conveyed in an agricultural machine can be guided into the measurement chamber through the inlet as a sample. The line can be separated from the inlet of the measurement chamber and, instead of the line, a filling device for introducing a (different) sample can be coupled to the inlet.

In other words, it is proposed to permanently or removably mount the sensor assembly on the agricultural machine so that, in a first (normal) measuring mode, material which is conveyed in the machine is introduced into a measurement chamber of the sensor assembly—in which the material is analyzed by the sensor—through a line and an inlet in a manner known per se, but to enable the sensor assembly to be reconfigured in the mounted state on the machine in such a way that the line is separated from the inlet and, instead of the line, a filling device is coupled to the inlet so that, in a second (different) measuring mode, a sample other than the material which is conveyed in the agricultural machine in each case is guided into the measurement chamber and analyzed there by the sensor. In the simplest case, with reconfiguration, the line may be removed manually from a fastening at the inlet and replaced by the filling device, although it would also be conceivable to install a manually adjustable or actuator-adjustable valve at the inlet or in the line, via which valve the inlet is optionally connected to the line to which the material from the machine is applied or to the filling device, which may be permanently or releasably mounted on the valve.

The filling device may be manually fillable by an operator and may comprise a funnel, for example. The operator may accordingly feed a material to be analyzed to the sensor assembly using the filling device. In the case of a harvesting machine, the operator may, for example, remove a sample from a container for the crop, e.g., from the grain tank of a combine harvester or from a load container which contains crop received and chopped by a field chopper, or from any other container or reservoir, using a vessel (bucket or the like) and empty the vessel into the filling device in order to analyze the crop using the sensor assembly.

The measurement chamber may comprise a first outlet, via which the material fed through the line can be fed back to the agricultural machine, and a second outlet, via which a (different) sample fed to the measurement chamber via the filling device can be guided out of the measurement chamber. Accordingly, the (different) sample is not fed back to the machine via the first outlet but conducted into the second outlet. This second outlet may be connectable to a container for receiving the sample which is discharged from the measurement chamber. In particular, the second outlet is arranged at the base of the measurement chamber, upstream of the first outlet, and is closable, be it by a plug or cover or a movable closure.

A conveyor, which is configured to convey the sample along the sensitive surface of the sensor, is preferably associated with the measurement chamber. It is thus possible to not only generate a single measurement value of the sample using the sensor, but to record a greater number of measurement values at different points of the sample which is gradually guided past the sensor (be it that the sample is guided past the sensor incrementally so that each area of the sample which is recorded by the sensor can be recorded for a relatively long measurement time or that the sample is guided past the sensor continuously and the sensor performs measurements at a predetermined frequency, e.g., 1 Hz) in order to reduce the measuring errors. Mean values from multiple measurements may be recorded here, in particular when measuring the different sample introduced via the filling device, or the individual measurement values may be recorded separately, in particular during the normal harvesting operation.

The conveyor is arranged downstream of the sensitive surface of the sensor, in particular in relation to the flow direction of the sample.

The sensor may be a near infra-red spectrometer, although any other sensors, such as cameras, capacitive hygrometers and the like, may be used as the sensor. The sensor assembly may comprise a single such sensor or a combination of two or more different sensors mentioned in this paragraph.

An agricultural machine, in particular harvesting machine, may be equipped with a described sensor assembly. The machine comprises means for conveying agricultural material, wherein the sensor assembly is configured to receive material which is conveyed in the machine through the line and to present it to the sensor as a sample so that the sensor may record the properties of the material. Accordingly, in the normal, first measuring mode, a proportion of the material moving in a conveyor channel in the agricultural machine (which proportion is diverted from the conveyor channel) or all of the material flowing in the conveyor channel (which then corresponds to the line) is conveyed into the sensor assembly.

A method for measuring properties of a crop or other sample using a sensor assembly, which comprises a sensor designed to record at least one property of a sample and a measurement chamber having an inlet for the sample, provides that, in a first measuring mode, the inlet is connected to a line through which material which is conveyed in an agricultural machine is guided through the inlet and into the measurement chamber as a sample and the sensor interacts with the sample contained in the measurement chamber and ascertains its properties, whilst, in a second measuring mode, the line is separated from the inlet of the measurement chamber and, instead of the line, a filling device for introducing a sample (other than that coming from the machine) is coupled to the inlet.

Other features and aspects will become apparent by consideration of the detailed description and accompanying drawings.

### BRIEF DESCRIPTION OF THE DRAWINGS

FIG. 1 is a schematic side view of an agricultural machine in the form of a combine harvester;

FIG. 2 is an enlarged detail of FIG. 1 and shows the grain elevator of the combine harvester with the sensor assembly;

FIG. 3 shows a section through the sensor assembly in a first configuration for analyzing a sample which is fed to the sensor assembly by the machine in the form of crop; and

FIG. 4 shows a section through the sensor assembly in a second configuration for analyzing a different sample, which is fed to the sensor assembly by an operator of the machine.

Before any embodiments are explained in detail, it is to be understood that the disclosure is not limited in its application to the details of construction and the system of components set forth in the following description or illustrated in the following drawings. The disclosure is capable of other embodiments and of being practiced or of being carried out in various ways. Further embodiments of the disclosure may include any combination of features from one or more dependent claims, and such features may be incorporated, collectively or separately, into any independent claim.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

As used herein, the term “controller” is a computing device including a processor and a memory. The “controller” may be a single device or alternatively multiple devices.

As used herein, the term “module” refers to any hardware, software, firmware, electronic control component, processing logic, processing device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

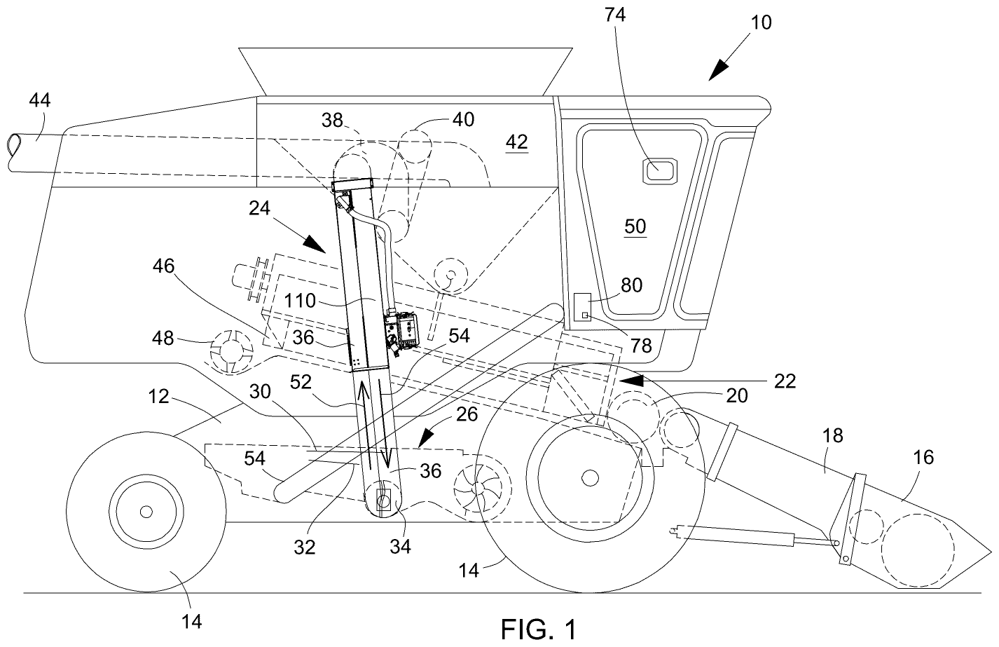

FIG. 1 discloses a harvesting machine in the form of a combine harvester 10 is shown as an example for an agricultural machine, which combine harvester comprises a main frame 12 with driven front wheels and steerable rear wheels 14, which are in engagement with the ground and support the main frame 12 for forward movement over a field to be harvested. Although wheels 14 are shown, the combine harvester 10 may be supported entirely or in part on crawler drives which are in engagement with the ground. An internal combustion engine mounted on the main frame 12 drives the wheels 14 via a conventional hydrostatic gear system. In the following text, direction indications (such as forward) relate to the forward direction of the combine harvester 10, which runs to the right in FIG. 1.

A vertically adjustable harvesting attachment in the form of a cutting unit 16 is used to harvest a crop and feed it to a feeder house 18. The feeder house 18 is pivotably linked to the main frame 12 and comprises a conveyor for feeding harvested crop to a guide drum 20. The guide drum 20 conveys the crop upwards through an inlet transfer portion 22 to a rotating threshing and separating assembly 24. Other orientations and types of threshing structures and other types of harvesting attachments may also be used, such as a transversely extending frame which supports individual row units.

During the harvesting operation, the rotating threshing and separating assembly 24 threshes and separates the crop. Grain and chaff fall through gratings at the base of the rotating threshing and separating assembly 24 into a cleaning system 26. The cleaning system 26 comprises a fan 28, upper sieves 30 and lower sieves 32, which separate the chaff. The clean grain is brought together over the width of the cleaning system 26 by a transverse auger conveyor 34, which feeds it to an elevator 36 for clean grain. The elevator 36 comprises chains and paddles and conveys the clean grain into a transfer portion 38 from which it is conveyed into a grain tank 42 by a grain-tank filling auger 40. The elevator 36 has an upwardly conveying branch (arrow 52) and a downwardly running (empty) branch (arrow 54). The clean grain in the grain tank 42 may be unloaded onto a grain truck or lorry by an unloading auger conveyor 44. Tailings are returned from the rear end of the lower sieve 32 to the rotating threshing and separating assembly 24 by a tailings elevator.

Threshed, separated straw is transferred from the rotating threshing and separating assembly 24 to a delivery conveyor 48 via an outlet 46. The delivery conveyor 48 expels the straw again at the rear side of the combine harvester 10. It should be noted that the delivery conveyor 48 could feed material other than grain directly to a straw chopper by the delivery conveyor 48. The operation of the combine harvester 10 is controlled from the operator's cab 50.

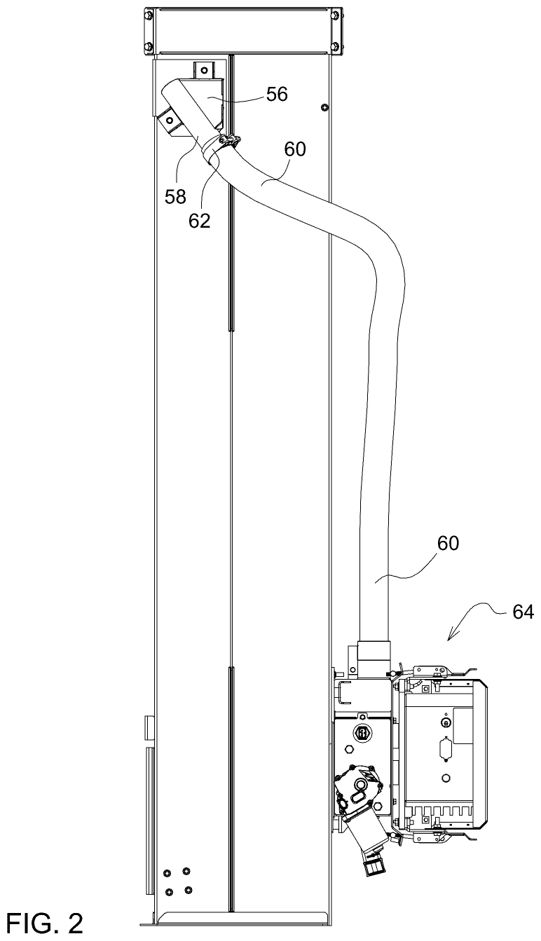

As is shown on an enlarged scale in FIG. 2, an opening in the side wall of the housing of the elevator 36, through which grain conveyed in the elevator 36 may exit, is present in the vicinity of the upper end of the upwardly conveying branch of the elevator 36. An inflow element 56 is arranged at the opening, which inflow element receives the grain exiting the elevator 36 and comprises a pipe connection 58 to which a flexible line 60 is attached via a clamp 62. The flexible line 60 extends downwards to a sensor assembly 64. During the harvesting operation, grain exits the elevator 36 continuously through the opening and is conducted to the sensor assembly 64 through the inflow element 56, the pipe connection 58 and the line.

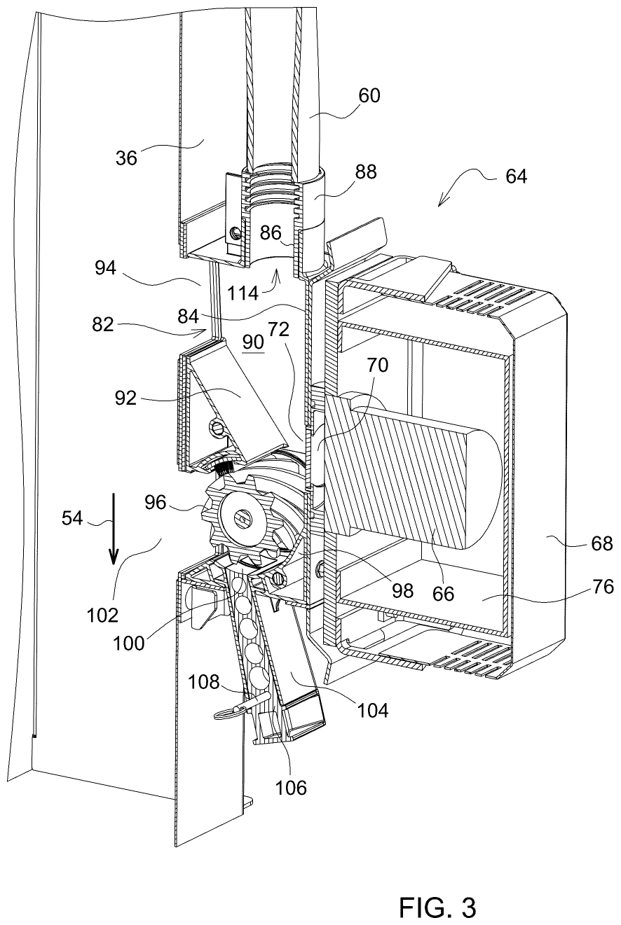

Reference is now made to FIG. 3, in which the sensor assembly 64 is shown in a normal, first measuring mode. The sensor assembly 64 comprises a sensor 66, which is mounted within a housing 68. The sensor 66 may be, in particular, a near infra-red spectrometer, which is directed into a measurement chamber 72 through a window 70 in the housing. In a manner known per se, the sensor 66, which is designed as a near infra-red spectrometer, comprises a light source with which the measurement chamber 72 is exposed to light in the infra-red range, and light-sensitive elements, which receive light reflected by a sample contained in the measurement chamber 72, which light is split according to wavelength. Based on the intensities of the light, which are recorded according to wavelength, and on stored calibration data, the proportions of certain substances in the sample may be ascertained by a computing device 76. The computing device 76 may be contained in the housing 68 or it may be separate from this. Analogously, a fiber optic could be mounted between the sample and the light-sensitive elements.

The computing device 76 is connected to a control 80 having a processor 78, which in turn communicates with a display device 74 and indicates the substance contents of the sample which are recorded in each case. The substance contents of the grain which are recorded by the sensor 66 may be displayed on the display device 74, stored by the processor 78 in a georeferenced manner and/or used by the control 80 for the automatic activation of operating parameters of the combine harvester 10. In this regard, adjustment of the threshing gap may take place according to the moisture in the grain as recorded by the sensor 66 in order to avoid unnecessary breakage in the case of dry grain.

The measurement chamber 72 is located within a holding assembly 82, which is in turn attached to the side wall of the elevator 36, The holding assembly 82 comprises a hollow housing 84, which is equipped with an upper connecting piece 86 to which the flexible line 60 is removably attached by means of a union nut 88. Below the upper connecting piece 86, the housing 84 of the holding assembly 82 forms a chamber 90. The wall 92 of the chamber 90 which is opposite the sensor 66 slopes downwards and towards the sensor 66 so that the chamber 90 tapers towards the bottom in the manner of a funnel and forms the measurement chamber 72 at the lower end of the wall 92. During operation, the sensor 66 records the properties or substance contents of a sample contained in the measurement chamber 72. In accordance with the claims, the lower end of the upper connecting piece 86 may be regarded as an inlet 114 of the holding assembly 82 and therefore also of the measurement chamber 72.

Above the chamber 90, the holding assembly 82 is provided with an opening 94, which is congruent with an opening in the side wall of the elevator 36. So long as the grain flowing into the chamber 90 and, below this, the measurement chamber 72 through the flexible line 60 is not discharged downwards through the measurement chamber 72 (i.e. if a conveyor 96 arranged below the measurement chamber 72 is stationary but grain is flowing in through the flexible line 60), it makes its way into the downwardly running branch of the elevator 36 via the opening 94 when the chamber 90 has been filled to the bottom edge of the opening 94 and is fed back to the upwardly running branch of the elevator, and therefore to the grain tank 42.

Arranged below the measurement chamber 72 is the conveyor 96, which, in the embodiment shown, is equipped with circumferentially distributed entrainment members (of helical design here) and can be driven about an axis extending horizontally and parallel to the side wall of the elevator 36 by a drive (not shown). The conveyor 96, which operates as an undershot conveyor, is arranged downstream of the measurement chamber 72 and, when rotated by the drive, conveys the grain out of the measurement chamber 72 so that new grain slips down from above and the conveyor 96 consequently conveys the grain or the sample through the measurement chamber 72 and along the sensor 66 so that further grain is therefore consistently analyzed, little by little, by the sensor 66.

A base 98 of the holding assembly 82 forms a trough below the conveyor 96, which trough is adapted to the envelope circle of the conveyor 96. When driven, the conveyor 96 conveys the grain from the measurement chamber 72, along the base 98 and through a first outlet 102 back to the downwardly running branch of the elevator 36. The first outlet 102 is formed by corresponding openings in the holding assembly 82 and in the side wall of the elevator 36. Upstream of the first outlet 102, the base 98 moreover comprises a second outlet 100 below the conveyor 96, which second outlet merges into a connecting piece 104 towards the bottom. In FIG. 3, the second outlet 100 and the connecting piece 104 are closed by a plug 106 (terminating level with the adjacent base 98), which is inserted into the connecting piece 104 and is locked there by a pin 108. The cross sections of the connecting piece 104 and the plug 106 fitting precisely therein are rectangular here.

In light of the foregoing, in a first measuring mode, the previously described design of the sensor assembly 64 enables grain to be conducted from the upwardly running branch of the elevator 36 into the measurement chamber 72 via the flexible line 60, to be analyzed there (as a sample) by the sensor 66, to be conveyed away from the measurement chamber 72 by the conveyor 96 and to be conducted back into the downwardly running branch of the elevator 36 through the first opening. The sample flows continuously past the sensor 66 here and the measurements take place at a specified frequency. The measurement values may be plotted in a georeferenced manner known per se, in particular compensating for the transit time of the crop from the respective original site of the crop on the field to the point where it reaches the sensor.

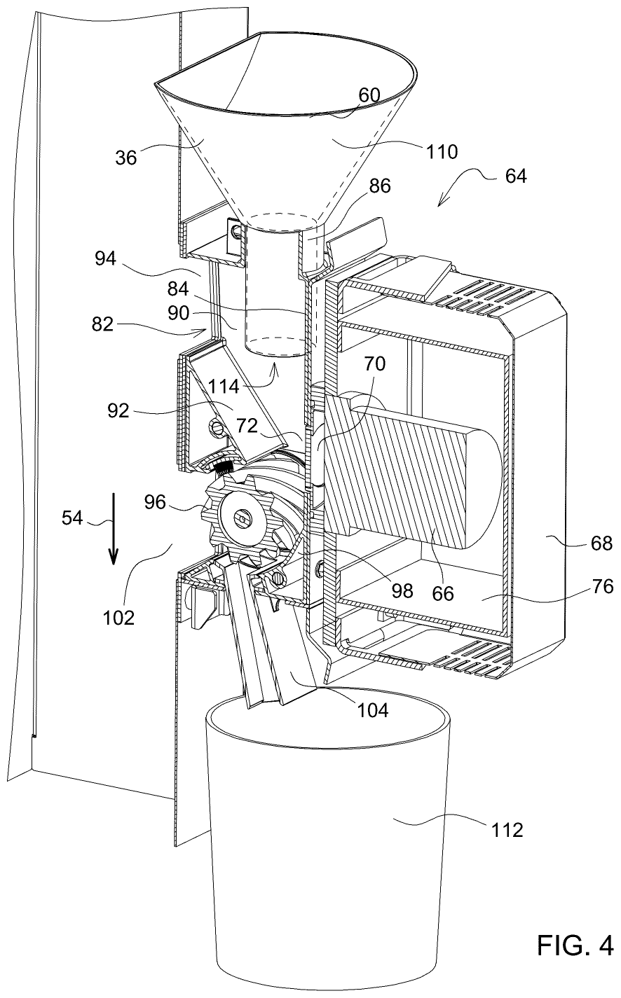

A sensor assembly 64 of this type (apart from the second outlet 100, the connecting piece 104 and the plug 106) is disclosed in U.S. patent application Ser. Nos. 18/312,841 and 18/312905 dated May 5, 2023, the content of which is incorporated in the present documents by reference. Further, similar sensor assemblies are also shown in FIGS. 2 and 4 of US 2002/0133309 A1, whereof the entire disclosure is likewise incorporated in the present documents by reference.

As shown in FIG. 4, a second measuring mode is also possible with the sensor assembly shown. In the second measuring mode, the flexible line 60 is removed from the upper connecting piece 86 (this is performed manually by an operator of the combine harvester 10—in particular without the use of a tool—by unscrewing the union nut 88 and pulling the flexible line 60 off the upper connecting piece 86) and, instead of this line, a filling device 110 in the form of a funnel is placed on the upper connecting piece 86. The cylindrical outflow element of the filling device 110 extends into the chamber 90. Moreover, the plug 106 is removed from the connecting piece 104 and a container 112 is positioned or otherwise fastened (suspended or the like) below the connecting piece 104. In the second measuring mode, when the combine harvester 10 is stationary but the sensor 66 and the drive of the conveyor 96 are energized, an operator may accordingly fill the filling device 110 with grain (from any source, e.g., from the grain tank 42 or from another container in which, for example, cereals are stored). The conveyor 96 then conveys the grain from the chamber 90 and into the measurement chamber 72 and it is analyzed (as a sample) by the sensor 66 and finally makes its way into the container 112 via the second outlet 100 and the connecting piece 104. When detecting the different sample fed in by the filling device 110 according to FIG. 4, multiple measurements are performed at a certain frequency, analogously to the normal operation, as the sample passes through the measurement chamber 72. The measurement values associated with a single bulk sample introduced to the filling device 110 are ascertained in a conventional manner and displayed and/or stored for the operator, e.g., in the sensor assembly or on the display device 74. The sensor 66 and the conveyor 96 here may be in continuous operation or they may be activated by operator input via a suitable interface (in particular on the sensor assembly, e.g., in the form of a (push-button) switch, possibly displaying the operating mode) or remote control.

Consequently, the sensor arrangement 64 is therefore designed to also analyze a (different) sample in a second measuring mode, which sample does not make its way into the measurement chamber 72 in which is it is analyzed by the sensor 66 via the flexible line 60, but from the filling device 110. This (different) sample is not fed back into the returning branch of the elevator 36, but is conducted into the container 112. However, it would also be conceivable to leave the plug 106 in the connecting piece 104 in the second measuring mode in order to conduct the (different) sample back into the elevator 36 following its analysis by the sensor 66. Another option also consists in opening the second outlet 100 (when the combine harvester 10 and conveyor 96 are stationary) and positioning a container 112 beneath it whilst the flexible line 60 is connected to the upper connecting piece 86, and then activating the conveyor 96 for a limited time so that the grain detected by the sensor 66 as a reference sample can be removed from the combine harvester 10 and analyzed in a laboratory for calibration purposes. To this end, automatic sample collection could also be provided, c.f. DE 10 2010 062 417 A1, and the second opening 100 could be opened and closed by an actuator-actuated closure. Various features are set forth in the following claims.

What is claimed is:

1. A sensor assembly comprising:
a sensor configured to record at least one property of a sample;
a measurement chamber having an inlet through which the sample is introduced into the measurement chamber;
wherein the sensor is configured to interact with the sample contained in the measurement chamber and to ascertain its properties;
wherein the inlet is connectable to a line through which material which is conveyed in an agricultural machine can be guided into the measurement chamber through the inlet as a sample;
wherein the line can be separated from the inlet of the measurement chamber and, instead of the line, a filling device configured for receiving a sample is coupled to the inlet.

2. The sensor assembly according to claim 1, wherein the filling device is manually fillable by an operator.

3. The sensor assembly according to claim 2, wherein the filling device comprises a funnel.

4. The sensor assembly according to claim 1, wherein the measurement chamber comprises a first outlet via which the material fed through the line is fed back to the agricultural machine and wherein the measurement chamber comprises a second outlet via which a sample fed to the measurement chamber via the filling device is guided out of the measurement chamber.

5. The sensor assembly according to claim 2, wherein the measurement chamber comprises a first outlet via which the material fed through the line is fed back to the agricultural machine and wherein the measurement chamber comprises a second outlet via which a sample fed to the measurement chamber via the filling device is guided out of the measurement chamber.

6. The sensor assembly according to claim 3, wherein the measurement chamber comprises a first outlet via which the material fed through the line can be fed back to the agricultural machine and wherein the measurement chamber comprises a second outlet via which a sample fed to the measurement chamber via the filling device is guided out of the measurement chamber.

7. The sensor assembly according to claim 4, wherein the second outlet is connectable to a container for receiving the sample discharged from the measurement chamber.

8. The sensor assembly according to claim 4, wherein the second outlet is arranged at a base of the measurement chamber, upstream of the first outlet, and is closable.

9. The sensor assembly according to claim 7, wherein the second outlet is arranged at a base of the measurement chamber, upstream of the first outlet, and is closable.

10. The sensor assembly according to claim 1, wherein a conveyor is associated with the measurement chamber, which conveyor is configured to convey the sample along the sensor.

11. The sensor assembly according to claim 2, wherein a conveyor is associated with the measurement chamber, which conveyor is configured to convey the sample along the sensor.

12. The sensor assembly according to claim 3, wherein a conveyor is associated with the measurement chamber, which conveyor is configured to convey the sample along the sensor.

13. The sensor assembly according to claim 4, wherein a conveyor is associated with the measurement chamber, which conveyor is configured to convey the sample along the sensor.

14. The sensor assembly according to claim 7, wherein a conveyor is associated with the measurement chamber, which conveyor is configured to convey the sample along the sensor.

15. The sensor assembly according to claim 8, wherein a conveyor is associated with the measurement chamber, which conveyor is configured to convey the sample along the sensor.

16. The sensor assembly according to claim 10, wherein the conveyor is arranged downstream of the sensor.

17. The sensor assembly according to claim 1, wherein the sensor comprises a near infra-red spectrometer.

18. The sensor assembly according to claim 2, wherein the sensor comprises a near infra-red spectrometer.

19. A harvesting machine comprising a sensor assembly and a device for conveying agricultural material, wherein the sensor assembly is configured to receive material which is conveyed in the harvesting machine through a line and to present it to the sensor assembly as a sample so that the sensor assembly may record properties of the material.

20. A method for measuring properties of a crop or other sample using a sensor assembly comprising a sensor configured to record at least one property of a sample and a measurement chamber having an inlet for receiving the sample;
providing one of a first measuring mode or a second measuring mode, wherein in the first measuring mode the inlet is connected to a line through which material which is conveyed in an agricultural machine is guided through the inlet and into the measurement chamber as a sample and the sensor interacts with the sample contained in the measurement chamber and ascertains its properties and in the second measuring mode the line is separated from the inlet of the measurement chamber and, instead of the line, a filling device for receiving a sample is coupled to the inlet.
